(19) United States
(12) Patent Application Publication
(10) Pub. No.: US 2005/0247210 A1
(43) Pub. Date: Nov. 10, 2005

(54) Electric cooking apparatus having removable heating plates and method for using same

(76) Inventor: Gary Ragan, Lebanon, NJ (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/119,629

(22) Filed: May 2, 2005

Related U.S. Application Data
(60) Provisional application No. 60/566,668, filed on Apr. 30, 2004.

(51) Int. Cl. A47J 9/00

(52) U.S. Cl. 99/372

(57) ABSTRACT

A cooking device including an upper housing and a lower housing is described. The lower housing is pivotally connected to the upper housing. The cooking device also includes a heating plate and a heating unit. The heating plate is removably attached to at least one of the upper housing and the lower housing. The heating unit is disposed in at least one of the upper housing and the lower housing and includes a heating element and a heat conducting plate between the heating element and the heating plate. The heat conducting plate conducts heat from the heating element to the heating plate.

### BACKGROUND OF THE INVENTION

1. Technical Field

The invention relates to kitchen appliances generally and, in particular to an electric cooking apparatus having removable heating plates suitable for automatic dishwasher cleaning.

2. Related Art

Table-top cooking devices today provide consumers with a portable, convenient, efficient and space-saving appliance. An example of such a table-top cooking device is described in U.S. Pat. No. 5,606,905 directed to an electric countertop grill having upper and lower grill plates that are connected by a hinge in a clamshell arrangement. The user places a food item on the lower grill plate and then closes the upper grill plate down upon it. The cooking space created by this configuration generally allows for cooking of both sides of the food item simultaneously and more quickly. Electric grills of this type continue to enjoy significant commercial success and they have become the cooking appliance of choice for many consumers.

Generally in such table-top appliances, the heating plates are adjacent the heating elements such that when power is supplied to heating elements, the heating plates are heated by the heating elements. A main drawback in conventional cooking devices such as this resides in that the heating plates cannot be removed, making cleaning the plates difficult and cumbersome. In order to facilitate cleaning and washing of such devices, some cooking devices include removable plates. However, the heating elements of the grill units below the heating plates may be undesirably activated when the plates are separated from the device, thereby exposing a nearby person or user to risk of severe burns from direct contact with the heating elements. Further, the prior grill units tend to heat unevenly leading to potentially undesirable cooking results.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 shows a cooking appliance according to the present invention.

FIG. 2 shows an exploded view of the cooking appliance of FIG. 1, illustrating, among other things, the placement of heating units beneath the operating position of the heating plates.

FIG. 3 shows the underside of one of the heating units which includes a heating element.

FIGS. 4a and 4b show a spring-lock mechanism, preferably located underneath the handle, used to releasably lock each heating plate of FIG. 1 to its respective housing. In particular, FIG. 4a illustrates the handle in a locked position, and FIG. 4b illustrates the handle in an unlocked position.

FIG. 5 shows a cross-sectional view of the cooking appliance of FIG. 1 in an open position with the heating plates in their respective operating positions.

FIG. 6 shows a flowchart which denotes a method for using of the cooking appliance.

FIG. 7 shows a cross-sectional view of the cooking appliance of FIG. 1 in a closed position.

It should be appreciated that for simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

### DETAILED DESCRIPTION OF THE EXEMPLARY EMBODIMENTS

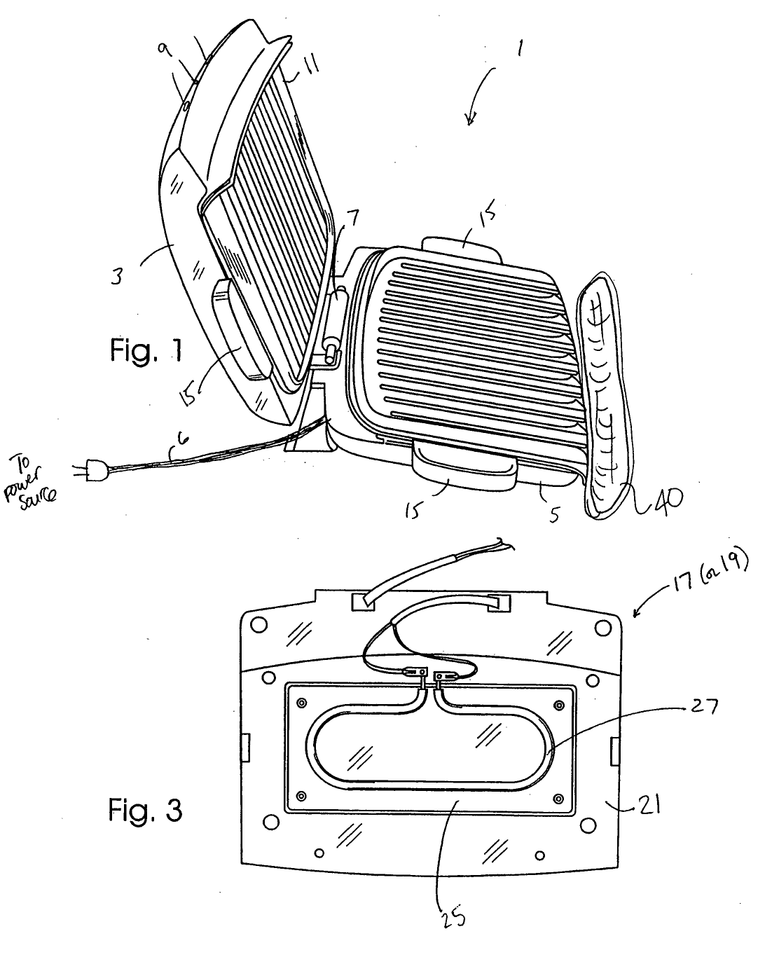

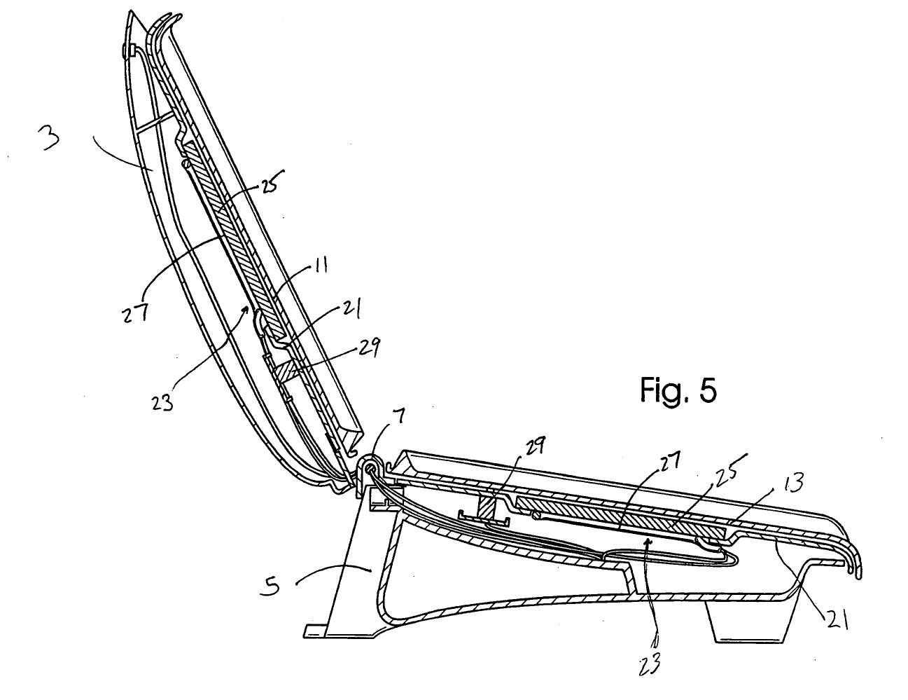

Referring to the Figures, according to a preferred embodiment of the present invention, a cooking appliance 1 is shown which includes an upper housing 3 and a lower housing 5 pivotally connected by a connecting unit 7. The connecting unit 7 interconnects the lower and upper housings 3 and 5 in such a manner that the upper housing 3 can be pivoted rearward from the lower housing 5 to an open position, in which the upper and lower housings 3, 5 are generally disposed at an obtuse angle between each other, as best shown in FIG. 1. In one embodiment, the connecting unit 7 may include a floating hinge to allow the relative vertical distance between the upper heating plate and the lower heating plate (when closed) to vary so that the appliance 1 can accommodate foods of varying thicknesses between the upper and lower plates. In a preferred embodiment, the lower housing is connected to a power source via a conventional power cord 6, and the upper housing 3 is preferably electrically coupled to the lower housing 5 via the connecting unit 7 (as shown in FIG. 5). However, other approaches to powering the apparatus are also possible, such as for example, a battery source or liquid or solid fuel sources. The upper housing 3 may include user input controls 9 for controlling the apparatus 1, such as for example, the power or temperature at which a food item will be cooked. The input controls may include a count-down timer that shuts off power to the heating units when it reaches zero.

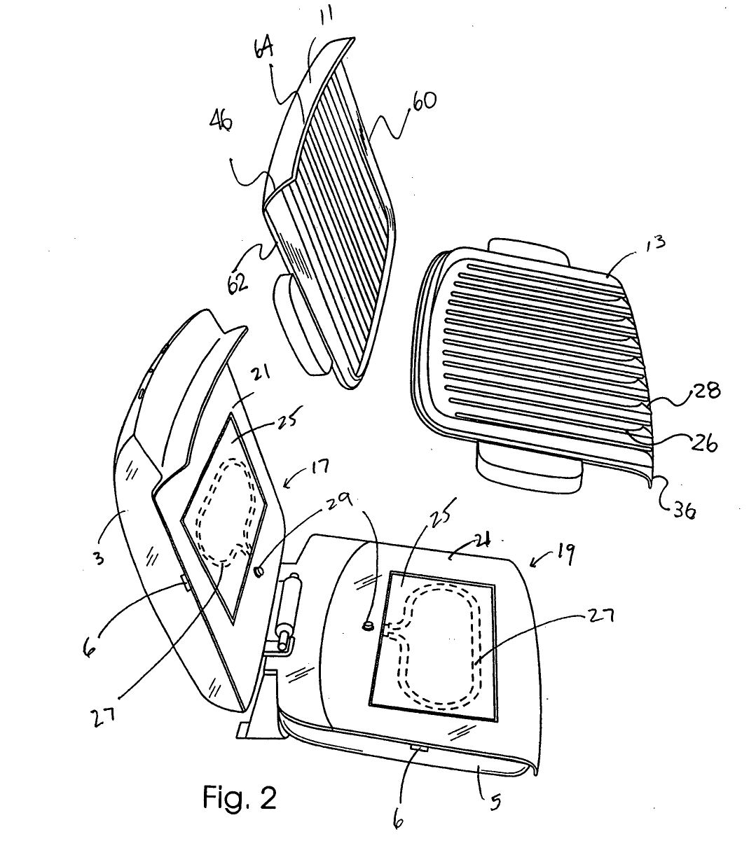

The upper housing 3 includes an upper heating plate 11 that is removably attached to the upper housing 3. In a preferred embodiment, such a removable attachment is accomplished by two handles 15 disposed substantially symmetrically in the upper heating plate 11. Preferably, the handles 15 are positioned on the side surfaces 60, 62 of the upper heating plate 11, and not the front surface 64 of the upper heating plate 11, as illustrated in FIG. 2. Positioning the handles 15 on the side surfaces 60, 62 helps prevent liquid emitted by foodstuffs within cooking chamber 20 during cooking therein from dripping on the handles 15.

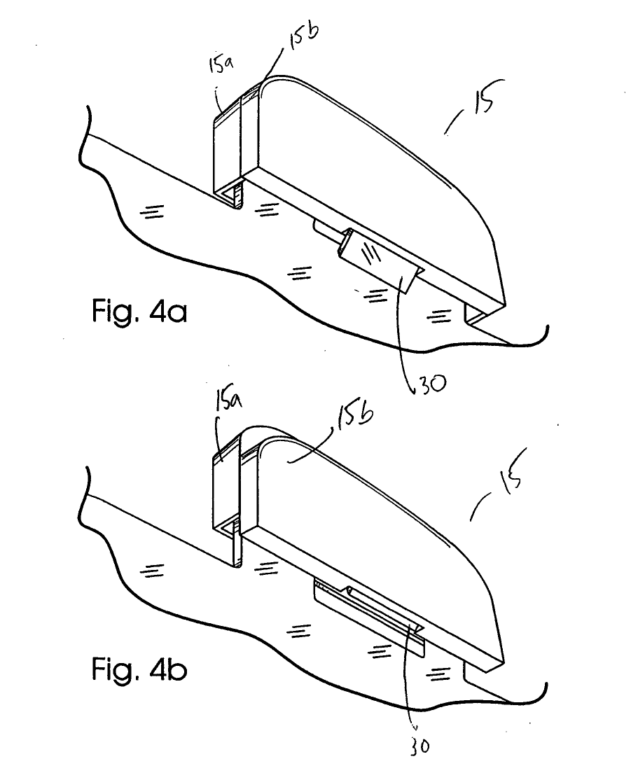

The cooking appliance 1 includes at least one release mechanism operable to remove the upper heating plate 11 from the upper housing 3. The release mechanism provides releasable attachment between the heating plates and the housings and may include a magnetic device such as an electromagnet; a mechanical device such as a latch or a spring-lock mechanism; and an electromechanical device such as an electronically activated mechanical latch. The release mechanism can be located anywhere within the cooking appliance 1, such as the upper or lower housings 3, 5. In one embodiment, each handle 15 has a release mechanism operable to remove the upper heating plate 11 from the upper housing 3. Preferably, the release mechanism is underneath the heating plate 11 (as shown more closely in FIGS. 4a and 4b). It is also possible for only one of the handles to have a release mechanism with the other handle having a fixed engagement point such as one about which the plate may be pivoted free from engagement with the upper housing. Similarly, the lower housing 5 includes a lower heating plate 13 that is removably attached to the lower housing 5 by similar handles 15. In a preferred embodiment, a user removes a plate by pulling the handles 15 outward (see FIG. 4b) so as to allow the plate to be lifted off of the respective housing. This mechanism via which the plate is locked to the housing is more fully described below with respect to FIGS. 4a and 4b.

The upper heating plate 11, when attached to the upper housing 3, is movable relative to lower heating plate 13, from an open position, in which the heating plates are generally perpendicular to each other, to a closed position, in which the upper heating plate 11 and lower heating plate 13 form a cooking chamber 20 (FIG. 7) which, due to the peripheries of the two heating plates overlapping, substantially restrains the escape of vapor therefrom. Preferably, the lower housing 5 and the upper housing 3 are pivotally connected by a floating hinge indicated at 7, such as the floating hinge shown and described in U.S. Pat. No. 5,363,748, issued Nov. 15, 1994, and assigned to the assignee of this application, which allows the top unit to move vertically, and to be pivotally moved relative to the base unit 12 from an open position (FIG. 1) to a closed position (FIG. 7). U.S. Pat. No. 5,363,748 also shows and describes the overlapping of the peripheries of upper and lower heating plates to substantially restrain the escape of vapors. The floating hinge also allows for the plates to remain relatively parallel to each other when in the closed position. This often allows for better contact between the upper and lower plates 11, 13 and the foodstuffs placed thereon for cooking.

Referring to FIG. 1, preferably lower heating plate 13 is positioned within appliance 1 and lower housing 5 at an angle to the horizontal plane of appliance 1, for example an angle of 12 degrees, although any acute angle to the horizontal plane of appliance 1 may be utilized.

Upper and lower heating plates 11, 13 may form a variety of grilling surfaces. For example, the upper and lower heating plates 11, 13 may form a grilling surface having ridges and indentations which are optimized for grilling sandwiches, waffles, toast, steaks, or other types of foodstuffs. For example, in one embodiment, the upper and lower heating plates 11, 13 may include a waffle-shaped pattern for making waffles or a sandwich-shaped pattern for making sandwiches. In one embodiment, the appliance 1 includes multiple upper plates 11 and multiple lower plates 13, each forming a grilling surface optimized for cooking one type of foodstuffs, and listed above.

In one embodiment, lower heating plate 13 supports a plurality of grilling members 26, which preferably are integral with lower heating plate 13, and are adapted to have a portion thereof contact foodstuffs placed thereon for cooking. Grilling members 26 extend upwardly from the plane of lower heating plate 13 and have at least their lower marginal end portions 28 extending upwardly to a greater elevation above lower heating plate 13 than the elevation of the opposite marginal portions 30 of grilling members 26 above lower heating plate 13. Upwardly extending portions 28 of grilling members 26 prevent foodstuffs from sliding or otherwise moving down and off of inclined grilling members 24. Lower heating plate 13, by being positioned at an angle to the horizontal plane, causes liquid emitted by foodstuffs within cooking chamber 20 during cooking therein, to be directed toward the lower end thereof, and lower heating plate 13 includes at least one downwardly extending portion 36, to which the liquid is directed.

In the embodiment of the present invention shown in FIGS. 1-7, the at least one downwardly extending portion 36 of lower heating plate 13 forms an opening 38 with a downwardly extending portion 46 on the upper heating plate 11, whereby liquid emitted during cooking is directed to and through opening 38. Preferably, appliance 1 includes a collecting member 40 (FIG. 7) positioned beneath opening 38 for collecting at least a portion of the liquid directed to downwardly extending portion 36 and passing through the opening 38. Preferably collecting member 40 is separable from and replaceable with respect to heating plates 11 and 13 for removing from the device liquid collected in the collecting member 40, and more preferably, collecting member 40 is readily accessible at the front of appliance 1 for removal therefrom.

It is understood herein that appliance 1 of the present invention having opening 38 and a collecting member, such as member 40, may provide for the removal of liquid and food, particularly foodstuffs in the form of cooked small pieces or ground foodstuffs. Removal thereof is effected by having liquid and grease emitted from the foodstuffs directed to and pass through opening 38 into member 40, and after cooking has been completed, first removing and disposing of the liquid and grease collected, and then replacing member 40 beneath opening 38, causing the cooked food to pass through opening 38 and into member 40 by being pushed, for example by a spatula (not shown), from grilling members 26 and lower heating plate 13, and then removing member 40 and tipping the food therefrom. In this manner cooked food can be removed from appliance 1 without tipping or turning over the device to remove the cooked food. Alternatively, heating plate 11 can include more than one downwardly extending portion with one portion being a well, such as a well 42, and another of the downwardly extending portions with an opening, such as a portion with an opening 38, can be utilized for removing cooked food from the device. As described in connection with well 42 in the second embodiment above, the well in this embodiment can retain liquid emanating from the foodstuffs being cooked, and optionally flavoring material placed therein, for supplying vapor thereof to the cooking chamber during cooking, or can be formed with an opening (not shown) for removal of collected liquid in the manner described above.

As shown in FIG. 2, each housing further includes fixedly attached heating units 17, 19 disposed so as to be thermally coupled to the upper and lower heating plates 11, 13, respectively, when plates 11, 13 are disposed in their respective operating positions. Each heating unit 17, 19 comprises a heat conductive plate 25 to which a heating element 27 is attached. This heat conductive plate acts as a heat sink that absorbs heat from the heating element 27 and then uniformly distributes it to the respective heating plates 11, 13. The heating element 27 is attached to the heat conductive plate 25 on one surface while the heat conductive plate 25 is thermally coupled to the respective heating plates 11, 13, when plates 11, 13 are disposed in their respective operating positions, via the opposite surface as shown in FIG. 3. The heating units 17, 19 are preferably disposed substantially in the center of the upper housing 3 and lower housing 5 in a cavity formed in each housing with a relatively large opening 23 (shown in FIG. 5) in the center. This opening 23 is completely covered by the heat conductive plate 25. So as illustrated in FIGS. 2 and 3, the lower heating plate 13, when locked on the lower housing 5 (the lower heating plate 13 and housing 5 are only referred to for explanatory purposes; the identical structure and description applies with respect to the upper heating plate and housing), is thermally coupled to the heat conductive plate 25 of the lower heating unit 19 via the top surface of the heating unit 19, while the heating element 27 for the lower heating unit 19 is located on the underside of the lower heating unit 19 (as shown in FIG. 3). This protects a user from risk of direct contact with the heating element 27 itself when the lower heating plate 13 is removed from the lower housing 5. The use of the heat conductive plate also substantially prevents food debris, oil, grease, or other substances from becoming lodged on or beneath the heating element 27. Moreover, this particular structure creates a thermal mass that operates to moderate the thermal input from the heat source, thus providing a uniform distribution of heat to the heating plate 13.

In a preferred embodiment, each heating unit 17, 19 has an associated safety interlock mechanism 29 which automatically shuts off power to the respective heating element 27 when the respective heating plates 11, 13 are removed from the upper and lower housings. In a preferred embodiment, the safety interlock mechanism 29 is an upwardly-based switch which is closed by the respective heating plate pressing against in its operative position it and opens when the heating plate is removed. When the switch is open, no electricity is conducted to the heating element 27, thus shutting off power to the heating element. This safety feature reduces risk of significant burns to a user if, for example, the user forgets to turn the appliance off before removing the heating plates 11, 13. While a safety interlock mechanism 29 is preferably included in both the upper and lower heating units 17, 19, it is possible to include the safety interlock with only one of the units.

FIGS. 4a and 4b together illustrate a preferred embodiment of a spring-lock mechanism, located underneath the handle, used to releasably lock each heating plate of FIG. 1 to its respective housing. In particular, FIG. 4a illustrates the mechanism in a locked position (i.e., the heating plate is locked onto the heating unit), while FIG. 4b illustrates the mechanism in an open or unlocked position, thus allowing removal of the heating plate from the heating unit. In this preferred embodiment, each handle 15 includes two movably connected pieces 15a and 15b, and a locking hitch 30. When the lower heating plate 13 is locked in place onto the lower housing, the locking hitch 30 grasps onto the lower housing via a small opening 6 in the housing (as illustrated in FIG. 2), so as to secure the lower heating plate 13 to the lower housing (not shown). When a user desires to remove the lower heating plate 13 from the lower housing, he or she pulls the surface portion 15a of each of the handles 15 outward, which causes the hitch 30 to retract into the interior portion 15b of the handle thus allowing the lower heating plate 13 to be lifted off and away from the lower housing. While the mechanism for locking the upper and lower plates are preferably identical, it is possible for them to have different constructions. The key is that there should be some positive engagement between the plates and the housings.

FIG. 5 illustrates a cross-sectional view of the cooking appliance of FIG. 1, taken across the center of the appliance. This cross-sectional view shows the each heating element 27 in thermal relation with the respective heat conductive plate 25, which in turn is in thermal relation with the respective heating plates 11, 13.

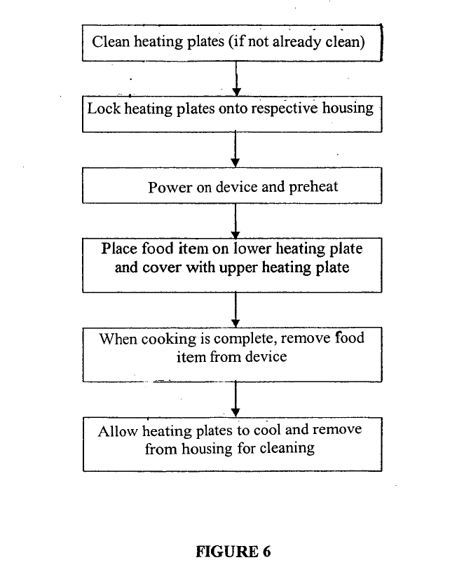

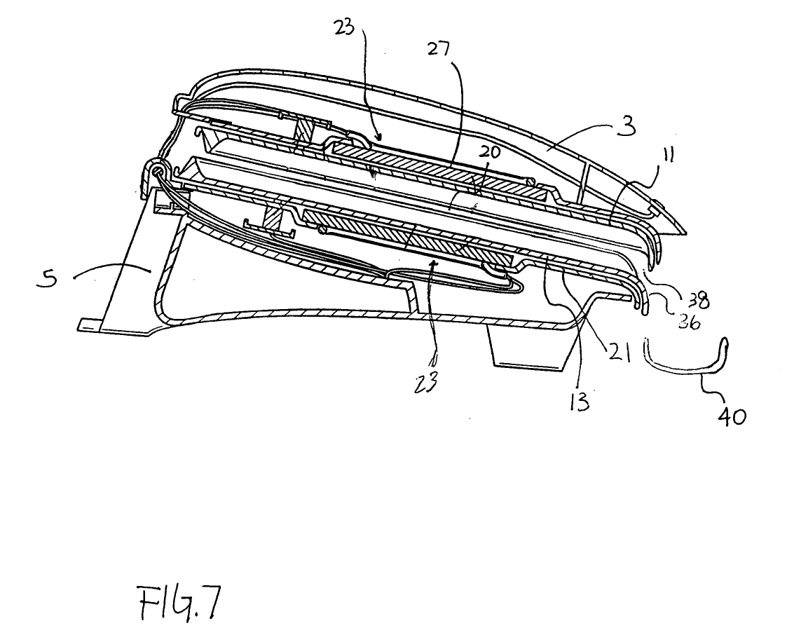

In general, the cooking appliance described herein may be used as follows (as illustrate by the flowchart shown in FIG. 6). First, the heating plates should preferably be cleaned, either by hand or in an automatic dishwasher. Because the plates are completely removable from the housing they may be fully submerged in water and/or an appropriate cleaning solution. Next, a user would lock the heating plates onto the respective housings of the cooking appliance. This step is described in further detail above with respect to FIGS. 4a and 4b. The cooking appliance may then be powered on and heated up in preparation for cooking a food item, by using the various user-input controls 9 on the upper housing 3. For example, the user-input controls 9 may include a time input (for controlling the cooking time), or a temperature input (for controlling the cooking temperature/power). While preferable, preheating is not required.

Once the heating plates are heated up, the food item may be placed on the lower heating plate, and then covered with the upper heating plate. The appliance 1 is then placed in the open position as shown in FIG. 1 moving the upper housing 3 away from the lower housing 5. The food to be cooked is placed on grilling members 26 on lower heating plate 13. The upper housing 3 is then pivotally moved to place the appliance 1 back into the closed position, as shown in FIG. 7. If a timer control is present in the device, the control is then set for the desired cooking time. As explained above, the heating occurs because the heating elements 27 transfer heat to their respective heat conductive plates 25, which, in turn, transfers heat to the respective heating plates 11, 15 for heating the food item.

During cooking, grilling members 26 on lower heating plate 13 contact the food directly thereby transferring heat and creating grilling marks on the lower surfaces of the food. Also during cooking, the temperature of the cooking surfaces seals juices in the foodstuffs. The overlapping configuration of upper heating plate 11 and lower heating plate 13, as shown in FIG. 7, will force any vapor trying to escape from cooking chamber 20 to travel down the inner peripheries of the two plates. The forcing of vapor down the peripheries of the two heating plates does not seal cooking chamber 20 but acts to substantially restrain the vapor within the chamber. Cooking juices given off by the foodstuffs during cooking drain toward downwardly extending portion 36 and through opening 38 to be removed therefrom to collecting member 40.

Once cooking of the food item is completed, the food item may be removed from the appliance 1. The cooking appliance 1 is disconnected from the power source and appliance 1 is then placed in the open position. The food is then removed from the lower heating plate 13 and grilling members 26. If downwardly extending portion 36 forms an opening 38, and collecting member 40 is present, collecting member 40 can be removed from lower housing 5 and liquid collected therein can be removed from the member 40. If small pieces or ground foodstuffs were cooked in the device, then member 40 can be returned to its position beneath downwardly extending portion 36 and opening 38 of heating plate 11, and the cooked foodstuffs can be pushed from grilling members 26 and lower heating plate 13 through portion 36 and opening 38 into collecting member 40, which can then be removed and the cooked foodstuffs removed therefrom.

When it is time to clean the cooking surfaces of the appliance, the user may simply remove the heating plates 11, 13 as described above by pulling the handles 15 outward so as to release the spring-lock mechanism underneath the plate (as shown in FIG. 5), and each plate may be lifted off of its respective housings 3, 5. The plates 11, 15 may then be submerged in water or washed in a dishwasher. The remainder of the housing can be wiped clean but not submerged in water or placed in a dishwasher. However, because the heating units 17, 19 are substantially sealed to the rest of the inner face of the upper and lower housings, the user need not be concerned that grease or food needs to be cleaned from the cavity or heating element 27.

While various embodiments of the application have been described, it will be apparent to those of ordinary skill in the art that many more embodiments and implementations are possible that are within the scope of this invention. Accordingly, the invention is not to be restricted except in light of the attached claims and their equivalent. For example, rather than being used in a two-surface appliance as described herein, the novel feature of a removable heating plate may also be used with a single-surface electric griddle, or an electric pancake, omelet or waffle maker.

1. A cooking device comprising:
an upper housing;
a lower housing pivotally connected to the upper housing;
a heating plate removably attached to at least one of the upper housing and the lower housing; and
a heating unit disposed in at least one of the upper housing and the lower housing, the heating unit including a heating element and a heat conducting plate between the heating element and the heating plate, wherein the heat conducting plate conducts heat from the heating element to the heating plate.

2. The cooking device of claim 1, wherein the heating unit further includes a safety interlock mechanism configured to turn off the heating element when the heating plate is removed from the at least one of the upper housing and the lower housing.

3. The cooking device of claim 1, wherein the at least one of the upper housing and the lower housing includes a cavity having an opening, the heating element is disposed within the cavity, and the heat conducting plate completely covers the opening.

4. The cooking device of claim 1, wherein the lower housing is pivotally connected to the upper housing by a connecting unit.

5. The cooking device of claim 4, wherein the connecting unit includes a floating hinge allowing the vertical distance between the upper housing and the lower housing to vary when the cooking device is in a closed position.

6. The cooking device of claim 1, wherein the heating plate includes two handles.

7. The cooking device of claim 6, wherein at least one handle is disposed substantially symmetrically in the heating plate.

8. The cooking device of claim 6, wherein at least one handle is positioned on a side surface of the heating plate.

9. The cooking device of claim 6, wherein at least one handle includes a release mechanism operable to remove the heating plate from one of the upper or lower housing.

10. The cooking device of claim 9, wherein the release mechanism includes one of a mechanical device, a magnetic device, and an electromechanical device.

11. The cooking device of claim 1 further comprising an upper heating plate removably attached to the upper housing and a lower heating plate removably attached to the lower housing.

12. The cooking device of claim 1, wherein the upper housing is movable relative to the lower housing from an open position, in which the upper housing is generally perpendicular to the lower housing, to a closed position, in which the upper housing is and the lower housing form a cooking chamber.

13. The cooking device of claim 1, wherein the heating plate forms a grilling surface with ridges which are optimized for grilling at least one of a sandwich, a waffle, a toast, and a steak.

14. The cooking device of claim 1 further comprising a collecting member positioned beneath an opening in the cooking device for collecting liquid.

15. A cooking device comprising:
an upper housing;
a lower housing pivotally connected to the upper housing;
a heating plate removably attached to at least one of the upper housing and the lower housing, wherein the heating plate includes two handles; and
a heating unit disposed in at least one of the upper housing and the lower housing.

16. The cooking device of claim 15, wherein the heating unit including a heating element and a heat conducting plate between the heating element and the heating plate, wherein the heat conducting plate conducts heat from the heating element to the heating plate.

17. The cooking device of claim 15, wherein at least one handle is disposed substantially symmetrically in the heating plate.

18. The cooking device of claim 15, wherein at least one handle is positioned on a side surface of the heating plate.

19. The cooking device of claim 15, wherein at least one handle includes a release mechanism operable to remove the heating plate from one of the upper or lower housing.

20. The cooking device of claim 15, wherein the release mechanism includes one of a mechanical device, a magnetic device, and an electromechanical device.

21. The cooking device of claim 15, wherein the handles are positioned on opposing side surfaces of the heating plate.

22. The cooking device of claim 15 further comprising an upper heating plate removably attached to the upper housing and a lower heating plate removably attached to the lower housing.

23. The cooking device of claim 22, wherein each heating plate include two handles.

24. The cooking device of claim 23, wherein the handles are positioned on opposing side surfaces of the heating plates.

25. A cooking device comprising:
an upper housing;
a lower housing pivotally connected to the upper housing;
a heating plate removably attached to at least one of the upper housing and the lower housing, wherein the heating plate supports a plurality of grilling members; and
a heating unit disposed in at least one of the upper housing and the lower housing, the heating unit including a heating element and a heat conducting plate between the heating element and the heating plate.

26. The cooking device of claim 25, wherein the grilling members are integral with the heating plate.

27. The cooking device of claim 25, wherein the grilling members extend upwardly from the plane of the heating plate.

28. The cooking device of claim 25, wherein the lower housing is positioned at an acute angle to a horizontal plane.

29. A cooking device comprising:
an upper housing;
a lower housing pivotally connected to the upper housing;
a heating plate removably attached to at least one of the upper housing and the lower housing,
a release mechanism operable to remove the heating plate from one of the upper or lower housing; and
a heating unit disposed in at least one of the upper housing and the lower housing, the heating unit including a heating element and a heat conducting plate between the heating element and the heating plate.

30. The cooking device of claim 29, wherein the heating plate includes a handle, and wherein the release mechanism is in the handle and is operable to remove the heating plate from one of the upper or lower housing.

31. The cooking device of claim 29, wherein the release mechanism includes one of a mechanical device, a magnetic device, and an electromechanical device.

32. The cooking device of claim 29 further comprising an upper heating plate removably attached to the upper housing and a lower heating plate removably attached to the lower housing.

33. The cooking device of claim 29, wherein the upper housing is movable relative to the lower housing from an open position, in which the upper housing is generally perpendicular to the lower housing, to a closed position, in which the upper housing is and the lower housing form a cooking chamber.

34. The cooking device of claim 29, wherein the heating plate forms a grilling surface with ridges which are optimized for grilling at least one of a sandwich, a waffle, a toast, and a steak.

35. The cooking device of claim 29 further comprising a collecting member positioned beneath an opening in the cooking device for collecting liquid.
